(19) United States
(12) Patent Application Publication
(10) Pub. No.: US 2015/0031398 A1
(43) Pub. Date: Jan. 29, 2015

(54) Zone-Based Information Linking, Systems and Methods

(71) Applicant: Flybits, Inc, Toronto (CA)

(72) Inventor: Hossein Rahnama, Toronto (CA)

(21) Appl. No.: 13/952,952

(22) Filed: Jul. 29, 2013

(51) Int. Cl. H04W 4/02

(52) U.S. Cl. CPC H04W 4/021
USPC 455/456.3

(57) ABSTRACT

Systems and methods of accessing and managing geo-fence zones are presented. Specific geo-fence zone addresses can be recognized by a document processing engine. Based on address identification rules, the processing engine identifies a zone address token, which is matched to the corresponding geo-fenced zone. A device configured with the processing engine can then link to the target zone or target zone service via the address.

### FIELD OF THE INVENTION

The field of the invention is geo-fence zone technologies.

### BACKGROUND

The following description includes information that may be useful in understanding the present invention. It is not an admission that any of the information provided herein is prior art or relevant to the presently claimed invention, or that any publication specifically or implicitly referenced is prior art.

With the growth of GPS enabled cell phones, consumers are able to attach to or otherwise consume location based services. Examples include Yelp™, Foursquare™, Google® Latitude™, or other services that provide data based on GPS coordinates of a person's cell phone. Unfortunately, such services are only provided based on GPS information and fail to offer consumers fine grained access to services based on boundary conditions. However, some effort has been directed to creating geo-location boundaries that can be used to provide location based services.

One example includes U.S. Pat. No. 8,018,329 to Morgan et al. “Automated Geo-Fence Boundary Configuration and Activation”, filed Dec. 12, 2008, which describes using some form of asset to trigger the automated construction of a geo-fence boundary. Additional effort applied toward managing geo-fence information includes U.S. patent application publication 2007/0143013 to Breen titled “System and Method for Updating Geo-Fence Information on Mobile Devices”, filed Dec. 16, 2005. Although Morgan and Breen provide some level of insight into geo-fencing per se, they restrict access to geo-fences information via dedicated applications.

Some effort has been directed to using geo-location to identify documents. For example, U.S. patent application publication 2013/0073388 to Heath titled “System and Method for Using Impressions Tracking and Analysis, Location Information, 2D and 3D Mapping, Mobile Mapping, Social Media, and User Behavior and Information for Generating Mobile and Interact Posted Promotions or Offers for, and/or Sale of Products and/or Services”, filed Jul. 8, 2012, describes providing access to sections within documents that are associated with a particular geographic coordinate. Heath also requires a dedicated application to access the documents.

Some further progress toward general purpose geo-fence location based services is made by U.S. patent application publication 2011/0029398 to Boudville titled “Geo Name Service for Validating Locations and Occupants and URLs”, filed Feb. 16, 2010. Boudville describes a name service that returns possible URLs of web sites or data feeds in response to a query that includes a location. Unfortunately, Boudville lacks insight in differentiating geo-fence zone addressing from other forms of addressing within a document. Boudville merely indicates that a GNS system can be used to store documents or to allow a user to designate which documents are relevant to which people.

Ideally, consumers would be able to access geo-fenced zone services via an addressing scheme that allow for general purpose differentiation among geo-fenced zone services. The applicant has appreciated that zones can and likely should be individually addressable via zone addresses, which enable consumers to access zone services directly via one or more documents.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

Thus, there is still a need for systems and methods of zone-based addressing.

### SUMMARY OF THE INVENTION

The inventive subject matter provides apparatus, systems and methods in which one can leverage a zone-specific address to access or otherwise manage zones. One aspect of the inventive subject matter includes a method of linking to a geo-fenced zone. Contemplated methods include configuring a device to process a digital document according to one or more zone address identification rules. The device can include a cell phone, tablet, kiosk, appliance, computer, phablet, vehicle, or any other suitably configured computing device. The processing engine (e.g. a word processor, browser, email application, document viewer, media player, messaging application, etc.) receives a digital document from a user, website, server, or another suitable source. The digital document can be a Word™ document, web page, or other type of file that stores text data, audio data, video data, game data, or other type of data. The document processing engine processes the digital document according to the zone address identification rules to determine if there are one or more addresses present. Through the use of the zone address identification rules, the engine identifies one or more zone address tokens (e.g., prefixes, suffixes, framing characters, etc.) indicative of document content that represents a zone address. The engine resolves the zone address tokens to a network address where the network address corresponds to a target zone. The engine further enables the device to link to the target zone according to the address.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 illustrates a schematic for a geo-fence addressing ecosystem.

FIG. 2 presents a possible method for differentiating among geo-fence zone services.

### DETAILED DESCRIPTION

Throughout the following discussion, numerous references will be made regarding servers, services, interfaces, agents, engines, modules, portals, platforms, or other systems formed from computing devices. It should be appreciated that the use of such terms is deemed to represent one or more computing devices having at least one processor configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. In especially preferred embodiments, the various servers, systems, databases, or interfaces exchange data using standardized protocols or algorithms, possibly based on HTTP, HTTPS, AES, public-private key exchanges, web service APRIs, known financial transaction protocols, or other electronic information exchanging methods. Data exchanges preferably are conducted over a packet-switched network, the Internet, LAN, WAN, VPN, or other type of packet switched network.

One should appreciate that the disclosed techniques provide many advantageous technical effects including linking a device to a geo-fence zone based on recognition signals sent to a document processing engine.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document, the terms “coupled to” and “coupled with” are used euphemistically to mean “communicatively coupled with” where two or more devices are able to communicate over a network, possibly via one or more intermediary devices.

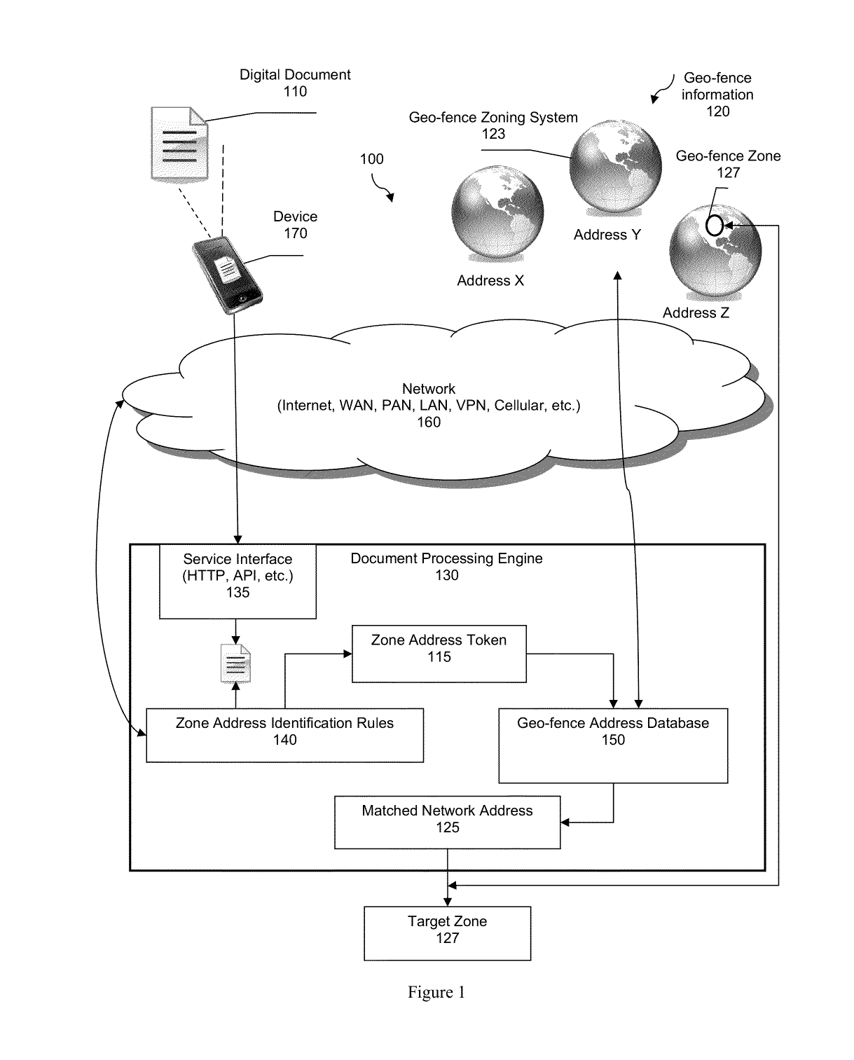

FIG. 1 illustrates geo-fence addressing system 100 comprising document processing engine 130 configured to or programmed to link the device to a target zone 127 or zone service based on a resolvable zone address. Examples of computing platforms that can be suitably adapted for use with the inventive subject matter within the device include Linux, Mac OS, Microsoft, Solaris, Android, BlackBerry OS, iOS, Embedded Linux, Palm OS, WebOS, Windows Mobile, VxWorks, or other suitable computing platforms that run document processing engines.

The following discussion describes document processing engine 130 as providing access to addressed target zone 127 and its services over a network 160. Document processing engine 130 can comprise a computer, or even a service as illustrated. In embodiments where document processing engine 130 operates as a service over network 160, document processing engine 130 can be considered a Platform-as-a-Service (PaaS), Infrastructure-as-a-Service (IaaS), Software-as-a-Service (SaaS), or other type of platform. Still, one should appreciate that document processing engine 130 can represent a variety of devices including a cell phone, personal computer, tablet, or other device. Thus, in some embodiments, a user can install an application on their smart phone where the application programs the cell phone to operate as document processing engine 130.

In the example shown, a user of device 170 obtains digital document 110 and enters it into the document processing engine 130. For example, one could download a file (e.g., image data, video data, audio data, speech data, motion data, acceleration data, temperature data, text data, biometric data, multimedia data, etc.) that comprises a representation of a zone address token (e.g., an image, text, etc.). Document processing engine 130 can receive digital document 110 over service interface 135 (e.g. cellular interface, GUI, API, HTTP server, shared memory, etc.).

Document processing engine 130 leverages zone address identification rules, possibly a priori integrated into document processing engine or obtained over network 160 from another device. Zone address identification rules 140 can operate based on non-address criteria such as a news event, an environmental factor, etc. Using these rules, the document processing engine 130 identifies a zone address token 115 within the digital document 110. Then, by accessing geo-fence information 120, perhaps from a Zone-Name Service (ZNS) system, via network 160, document processing engine 130 matches the zone address tokens to the corresponding geo-fence system network address 125 from a geo-fence address database 150. It is contemplated that the geo-fence address database 150 comprising of geo-fence information 120 can reside outside document processing engine 130. The geo-fence address database 150 can be located in device 170, a hard drive, on the network, in the cloud, other digital memory storage mechanism. Device 170 then communicatively links to the appropriate target zone 127 or its service upon activation of the zone address.

It is contemplated that upon communicatively linking to a target zone 127, device 170 can consume services of target zone 127. The nature of the services depends on the features constructed for the zone. In some consumer embodiments the zone services could provide access to product information, travel applications, or other features. From a zone management perspective, the zone services could also provide a management interface through which target zone 127 can be managed. Thus, device 170 can consume management services to modify the nature of target zone 127 itself.

One should appreciate that document 110 can be created by device 170. As content is added to document 110, document processing engine 130 can apply zone address identification rules 140 to the content to determine if one or more zone address tokens are present. If so, document processing engine 130 can highlight the address tokens assuming corresponding zone addresses should be activated.

One should appreciate that device 170 can be communicatively linked to multiple target zones 127 within the same geo-fence zoning ecosystem or from separate geo-fence zoning systems. Thus, users of device 170 can possibly benefit from zone services from multiple geo-fence zoning systems.

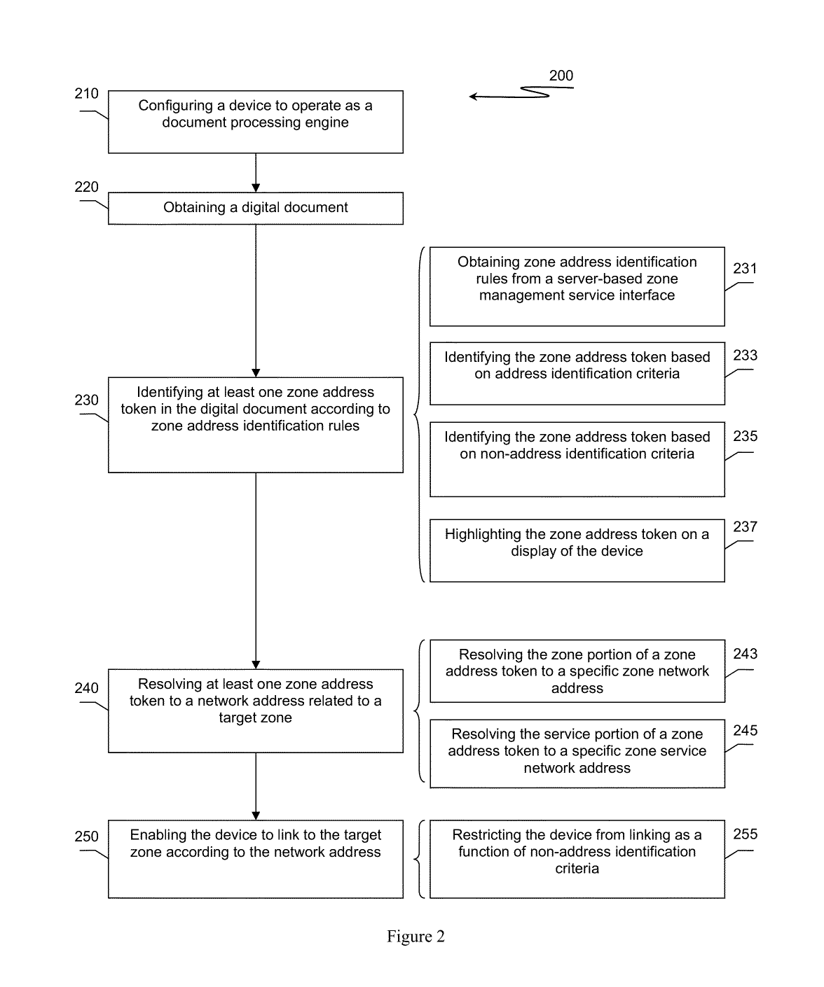

FIG. 2 presents method 200 of linking a device to a target geo-fence zone where an entity can access target zone services through an addressing scheme that allows generic applications (e.g., email, browsers, word processors, etc.) to link to any type of zone. One should appreciate that each geo-fence zone can be arbitrarily created by an individual or zone manager as a persistent set of zone-based services. The zone manager can instantiate a zone via a zone management system as described in the applicant's own work: U.S. patent application having Ser. No. 13/722376 to Rahnama titled “Zone Oriented Applications, Systems and Methods”, filed Dec. 20, 2012; and U.S. patent application having Ser. No. 13/722416 also to Rahnama “Zone Oriented Applications, Systems and Methods” filed Dec. 20, 2012.

Step 210 includes configuring a device to operate as a document processing engine. Example devices include a cell phone, a tablet, a kiosk, an appliance, a computer, a phablet, a vehicle, or other computing and preferably networked devices. The device can be configured through installation of one or more sets of software instructions (e.g., applications, software, apps, etc.) within the non-transitory, computer readable memory of the device where the instructions cause the device's processor to execute the various steps of method 200. For example, a cell phone can be configured to operate as a document processing engine by installing a suitably configured document processing application on the cell phone (e.g., email reader, PDF read, office productivity suite, browser, etc.). In other embodiments, a user might use their personal computing device to engage a remote server operating as a for-free service that accesses digital documents.

Configuring the device can also include integrating one or more zone address identification rules within an application. Such rules can be integrated within existing, popular applications possibly including Outlook®, Word®, Adobe Acrobat®, etc., and can be an internal module, plug-in, external module, OS module, or other type of module. The zone address identification rules govern how a digital document should be processed to identify zone address tokens. The zone address identification rules can depend on the nature or modality of the digital document. In some embodiments, the document processing engine can include a document modality conversion module that converts at least a portion of the digital document from a first modality to a second modality that it is more suitable for identifying zone addresses. Consider an example where a person captures an image of a billboard or poster that displays a text-based zone address, possibly corresponding to an advertiser's products. The document processing engine on the cell phone can apply one or more optical character recognition (OCR) algorithms to derive the apparent text in the image. The engine can then apply the zone address identification rules to the text data.

A document processing engine comprises the device programmed with one or more of the following applications: a word processor, a browser, an email application, a document viewer, a media player, a messaging application, or any other suitable document processing engine. It is further contemplated that a document processing engine can include a mechanism for separating multimedia data into separate data types to then be processed. For example, the document processing engine can obtain a multimedia digital document, then separate, and process only the audio portion as discussed above with respect to the document modality conversion module.

Step 220 includes obtaining a digital document. The processing engine can obtain the digital document through various techniques. In embodiments where the device operating as the processing engine comprises a hand held device, the device can obtain the digital document over a network connection (e.g., wireless, WiFi, Internet, cellular, etc.). It is also contemplated that the device can obtain the digital document by instantiating the document itself, perhaps via a captured image or a newly created document (e.g., file, email, etc.). In other embodiments where the device comprises a server, the server could obtain the document over a network connection or possibly from a file system configured to store documents. In more specific scenarios, the digital document can be obtained via email, web page, real-time editing, social media, cloud service, hard drive, memory card, or by FTP (using an FTP program or browser), HTTP put, HTTP get, push models, pull models, or any other mechanism for accessing or retrieving digital documents. It is contemplated that obtaining the digital document can also require authentication.

The digital document can contain a broad spectrum of data types including any of the following: image data, text data, audio data, video data, game data, and any other suitable type of data or combination of types of data. The digital document can also contain movie content, television content, radio content, podcast content, telecommunication content, internet streamed content, or any other media content. For each type of data, it is contemplated that the digital document can be a variety of formats. For example, audio data can be formatted in WAV, MP3, AIFF, AAC, M4A, M4P, etc. The zone address identification rules can be modified as necessary to accommodate the various document formats.

It is further contemplated that a digital document can contain real time data being transmitted to the configured device. For example, a streaming video being recorded by a cell phone camera, either on the device's hard drive, RAM memory, cloud service, or other suitable permanent or temporary digital storage location. Another example is recording a specific spoken word or sound into the device's audio recorder in real time. Individuals can then have the ability to access another's geo-fence system with a simple command instead of requiring a specially formatted digital document.

Step 230 includes identifying at least one zone address token in the digital document according to the zone address identification rules. A zone address token can be any suitable type of recognizable token or symbol within the document. The address tokens comprise data elements within the document that denote that corresponding elements are in fact a zone address. The data elements can include text characters, symbols, or other constructs. In some embodiments, a zone address token can comprise framing characters, for example, “{}”, “[]”, “<>”, “( )”, and “||” where the framing characters enclose data elements representing the zone address. For example, a zone address could be of the form {Flybits} where the curly braces are framing the framing characters around the address name “Flybits”. A document processing engine can be configured via the zone address identification rules to recognize the framing characters. Further, the engine recognizes that the enclosed data elements, the text “Flybits” in this example, are resolvable. The example framing characters include homogeneous characters. One should further appreciate that heterogeneous characters can also form framing characters, perhaps “+” and “−” (e.g., “+Flybits−”), “˜{“and”}˜” (e.g., ˜{Flybits}˜), or “@” and “!” (e.g., “@Flybits!”). The quotes used in the preceding examples are for clarity and are not part of the addressing scheme unless dictated by the zone address identification rules. A zone address token can also be in the form a prefix token or suffix token within proximity to a zone name within the digital document. Examples zone address could be of the form “[zone name prefix][service](zone symbol)” or “[service](zone symbol)[zone name suffix]”. As example consider a scenario where Flybits provides travel services for arriving or departing passengers within airport zones. The address for arriving passengers might be of the form “LAX-arrivals%” (i.e., a prefix form) or “departures%LAX” (i.e., a suffix form) where LAX is the zone name, the service names are “arrivals” and “departures”, and the “%” symbol denotes that these are a zone address. Based on these examples one should appreciate that a zone address token can contain a zone portion and a zone service portion.

Step 231 includes obtaining zone address identification rules from a server-based zone management service interface. The zone address identification rules can be a priori integrated into the document processing engine as a native feature. In other embodiments, the rules can be packaged as an add-on module or plug-in that can be integrated within an application or operating system. The rules can be packaged into one or more formats that are preferably understandable by the document processing engine. For example, the zone address identification rules can be packaged as an XML file, script file, compiled code, or other formats that can be ingested by the document processing engine.

The zone address identification rules provide the document processing engine with instructions on where and how to identify zone address tokens within a digital document. For example, these rules can instruct the document processing engine to identify the first 5 characters in the document as the address token; search for the character string ‘< . . . >’ which will contain an address token; or other document features. It is further contemplated that the zone address identification rules can also instruct the document processing engine on identifying and separating the zone portion from the zone service portion of the token.

The rules can also comprise non-address identification criteria as indicated by step 235. Examples of non-address identification rules include: a context, a location, a time, a news event, an environmental condition, a sensor data, a transmitted command or signal, a device condition, or any other suitable non-address identification rule. Other examples of non-address rules include: user preferences, user identification, zone definition, user context definition, regular expressions, scripts, transactions, or other rules.

Another example of non-address criteria is a specific set of actions to be performed by the user within the geo-fence zone. If successfully performed, the device can proceed to identify the zone address token, match the token to its corresponding geo-fence address, and link to the target zone or zone service. One contemplated application is an interactive game system where links equate to increases in levels within the game.

It is contemplated that non-address identification criteria can restrict the identification of zone address tokens. The identified zone address token can also be highlighted on a display of the device within the digital document as suggested by step 237.

Suitable techniques that can be adapted for use with the inventive subject matter include those disclosed in U.S. patent application 2011/0256881 to Huang et al. titled “Context-Based Reverse Geocoding” (“Huang”), filed Apr. 20, 2010. Huang's techniques can be adapted to use context information to select valid geo-fences based on non-address information pattern movement The inventive subject matter is considered to include activating a zone address that is making the zone address “visible” to the document processing engine, based on contextual information.

Similarly, U.S. patent application publication 2012/0284769 to Dixon et al. titled “Systems and Methods of Intelligent Policy-Based Geo-Fencing” (“Dixon”), filed May 6, 2011, also uses context. Dixon's techniques can also be adapted to use as non-addressed based context information to select geo-fences.

The zone address identification rules can operate according to one or more techniques. Some embodiments include rules for scanning a document for regular expressions defined based on zone address token information. Once corresponding zone addresses are found, the document processing engine can construct the zone address. It is further contemplated that the zone address identification rules can be tailored to the specific type of document e.g., HTML, docx, etc. A set of rules can consist of individual rules each applicable to only certain type(s) of documents.

The use of the zone address identification rules can be conditional on an event internal to the device. For example, the zone address rules can be set to be used only upon the receipt of a digital document or even a specific type of digital document; or the rules can be activated only upon a user's affirmative command. The use of the zone address identification rules can also be conditional on an event external to the device. For example, the rules can be activated only upon being within a certain proximity to the target zone or zone boundary based on geo-location of the device; or the rules can be activated upon an external application's command. Consider interactive games as a use case. Playing an interactive game and unlocking a subsequent level can activate specific zone address identification rules that provide links the next level's geo-fence zones.

Zone address identification rules can also trigger specific actions upon the successful or unsuccessful identification of a zone address token. For example, the zone address identification rules can trigger an authentication process before allowing a device to access a target zone. Additionally if no zone address token is found within the digital document, the zone address identification rules can trigger a module within the device to display an error message to the user.

It is also contemplated that the zone address identification rules can create a trigger point for external applications. The rules can instruct the device to communicatively link to another application upon receipt of the digital document. In this way, social networks like Yelp™ can access zone information and provide the user with services pertaining to the target geo-fence zone without having to manually input zone information.

Step 240 includes resolving at least one zone address token to a network address related to a target zone. As discussed above, the zone address can comprises one or more zone address tokens where a zone portion of the zone address token differentiates among zones, or a zone service portion of the zone address token differentiates among services within a zone. Thus, step 243 can include resolving the zone portion of the zone address token to a specific zone's network address and step 245 can include resolving the zone service portion of the zone address token to a specific zone's services network address. A network address can be one of the following: an IP address, a URL, a top level domain (DNS), a transport-layer port, a protocol address, a phone number, Ethernet MAC address, or any other suitable network address format. U.S. patent application publication 2011/0029398 to Boudville titled “Geo Name Service for Validating Locations and Occupants and URLs”, filed Feb. 16, 2010 describes a Geo Name Service (GNS) that returns a URL based on a location query. However, Boudville fails to provide for resolving actual zone addresses. The inventive subject matter is considered to include construction of a Zone Name Service (ZNS) that resolves zone addresses to one or more accessible network addresses. Some embodiments could augment the Boudville system to with the inventive subject matter disclosed herein to construct a ZNS system.

Step 250 includes enabling the device to link to the target zone according to the network address. It is further contemplated that the device can link to the target zone service itself Further, the device can be restricted from linking as a function of non-address identification criteria as suggested by step 255. For example, although the user is within a geo-fence zone, the device can be restricted from linking to the target zone service because the user has an external application opened within the device that already provides the service.

It is contemplated that a highlighted zone address link to the target zone or target zone service can gradually disappear on the display screen as the user moves closer or father from the boundary. The same can be done for the reappearance of the link as the user moves closer or farther from the geo-fence zone boundary.

The following examples provide market context for the disclosed inventive subject. Each of the examples can be considered possible embodiments.

As an example, consider scenario where a person attends a public event, possibly at an unfamiliar venue (e.g., auditorium, stadium, concert hall, etc.). The person's cell phone could include one or more email reminders that provide zone addresses corresponding to the venue as well as the specific event. The person's cell phone, operating as a processing engine, analyzes the email reminder and highlights the zone addresses. Upon activation of the venues zone address when the person's device enters the zone of the venue, the device can link to the venue's zone parking navigation services among other venue specific services. The event zone, which could be an overlapping zone, could offer other services linked to the zone addresses where the event services could be distinct from the venues. Example linkable event services could include ticket sales, playbill information, player information, or other information.

Another use can be in the context of interactive gaming. The game itself can include a geo-fence system along with zone address identification rules and digital documents for game access. Because zone address identification rules can be dependent on non-address content or context (e.g., game rules), target zones and zone services can be linked by the device based on the game rules. The services can include game event notifications, awards, game information, game standing, the status of nearby opponents within one's zone, or other services. Further, individuals interested in multiple interactive games incorporating geo-fence zoning will save memory space on their electronic devices by not necessarily needing to download large individual applications for each game. Instead, one geo-fence addressing system can be used in conjunction with smaller files consisting of the zone address identification rules (which may be accessed via network), and digital documents for accessing the geo-fence zones.

A geo-fence addressing scheme can also be useful within the context of security. Secure facilities can create a geo-fence zone system with a set of zone address identification rules and digital documents distributed to the appropriate people containing zone address tokens with a service portion corresponding to that person's allowed access. The service can both provide access into specific areas as well as send notifications to the individual or the facility's security of any unauthorized access. This way, each secure facility does not require its own security access/notification application. Instead, each creates a geo-fence system and applies the necessary zone address identification rules and zone services for its specific needs.

Yet another example includes machine-level services. A machine or appliance (e.g., washing machine, refrigerator, security system, etc.) can be deployed within a zone and download a document having relevant consumable services. Further, the machine can publish its services within the context of the zone. The machine's capabilities (e.g., data, services, etc.) can be accessed via a zone address that references the machine's services. For example, a refrigerator might be disposed within a zone having the address {Flybits}. The refrigerator can register its services with the Flybits and then the zone can provide the services by corresponding address. Perhaps temperature information could be accessed via the zone address {Flybits%refrigerator.temp} or the inventory of the refrigerator could be access via the zone address {Flybits%refrigerator.inventory}. One should appreciate that zone addressing schemes can represent the semantic or ontological nature of the zone or zone services.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method of linking to a geo-fenced zone, the method comprising:
configuring a device to operate as a document processing engine according to zone address identification rules;
obtaining, by the document processing engine, a digital document;
identifying, by the document processing engine, at least one zone address token in the digital document according to the zone address identification rules;
resolving the at least one zone address token to a network address related to a target zone; and
enabling the device to link communicatively to the target zone according to the network address.

2. The method of claim 1, further comprising obtaining, by the device, the zone address identification rules from a server-based zone management service interface.

3. The method of claim 1, wherein the step of configuring the device includes configuring at least one of the following devices to operate as the document processing engine: a cell phone, a tablet, a kiosk, an appliance, a computer, a phablet, and a vehicle.

4. The method of claim 1, wherein the step of configuring the device includes integrating the zone address identification rules within an application.

5. The method of claim 1, wherein the document processing engine includes at least one of the following: a word processor, a browser, an email application, a document viewer, a media player, and a messaging application.

6. The method of claim 1, wherein the digital document comprises at least one of the following types of data: image data, text data, audio data, video data, and game data.

7. The method of claim 1, further comprising enabling the device to link to a zone service according to the network address and to the at least one zone address token.

8. The method of claim 1, wherein the zone address token comprises a zone portion and a zone service potion.

9. The method of claim 8, wherein the step of resolving the at least one zone address token to the network address includes resolving the zone portion to a specific zone network address.

10. The method of claim 8, wherein the step of resolving the at least one zone address token to the network address includes resolving the service portion to a specific zone service network address.

11. The method of claim 1, wherein the at least one zone address token comprises a prefix token in proximity to a zone name within the digital document.

12. The method of claim 1, wherein the at least one zone address token comprises a suffix token in proximity to a zone name within the digital document.

13. The method of claim 1, wherein the network address comprises at least one of the following: an IP address, a URL, a top level domain, a transport-layer port, a protocol address, and a phone number.

14. The method of claim 1, wherein the at least one zone address token comprises framing characters.

15. The method of claim 14, wherein the framing characters are selected from the group consisting of: “{}”, “[]”, “<>”, “( )” and “||”.

16. The method of claim 14, wherein the at least one zone address token comprises a zone name framed by the framing characters.

17. The method of claim 1, further comprising highlighting the zone address token on a display of the device within the digital document.

18. The method of claim 1, wherein the zone address identification rules comprises non-address identification criteria.

19. The method of claim 18, wherein the step of identifying the at least one zone address token depends on the non-address identification criteria.

20. The method of claim 18, wherein the non-address identification criteria depend on at least one of the following: a context, a location, a time, a news event, an environmental condition, and sensor data.

21. The method of claim 18, further comprises restricting identification of the at least one zone address token as a function of the non-address identification criteria.

22. The method of claim 18, further comprises restricting the device from linking to the target zone as a function of the non-address identification criteria.

23. The method of claim 18, further comprising highlighting the zone address token on a display of the device within the digital document according to highlighting rules within the zone address identification rules as a function of the non-address identification criteria.

24. The method of claim 1, wherein the zone address identification rules comprise at least one of the following: a user preference, a user identification, a zone definition, a user context definition, a regular expression, and a script.
